(19) United States
(12) Patent Application Publication
(10) Pub. No.: US 2015/0073892 A1
(43) Pub. Date: Mar. 12, 2015

(54) SYSTEMS AND METHODS FOR OPENING AN APPLICATION ASSOCIATED WITH AN ADVERTISEMENT

(71) Applicant: Tune, Inc., Seattle, WA (US)

(72) Inventors: Lucas Brown, Seattle, WA (US); Lee Brown, Seattle, WA (US)

(21) Appl. No.: 14/480,479

(22) Filed: Sep. 8, 2014

Related U.S. Application Data
(60) Provisional application No. 61/983,967, filed on Apr. 24, 2014.
(60) Provisional application No. 61/952,753, filed on Mar. 13, 2014.
(60) Provisional application No. 61/874,913, filed on Sep. 6, 2013.

(51) Int. Cl. G06Q 30/02; H04L 29/08; G06F 9/445

(52) U.S. Cl. CPC G06Q 30/0246; G06F 8/61; H04L 67/10; G06Q 30/0267
USPC 705/14.45; 717/178

(57) ABSTRACT

Systems and methods for launching an advertised application to perform an intent are provided. An advertisement for an application is created, and an intent (such as playing indicated media) is associated with the advertisement. Upon interacting with the advertisement on an end user computing device, the application is launched and passed the intent for processing, if the application is installed on the end user computing device. If the application is not installed on the end user computing device, the application is downloaded and installed on the end user computing device, and the intent is provided to the application upon the first execution of the application for processing.

### CROSS-REFERENCES TO RELATED APPLICATIONS

This application claims the benefit of U.S. Provisional Application No. 61/983,967, filed Apr. 24, 2014; U.S. Provisional Application No. 61/952,753, filed Mar. 13, 2014, and U.S. Provisional Application No. 61/874,913, filed Sep. 6, 2013, the entire disclosures of which are hereby incorporated by reference herein for all purposes.

### BACKGROUND

Traditionally, advertisements may promote an application for use on mobile computing devices. A link associated with the advertisement may lead the user to a download location for the application, and may provide tracking functionality for recording the interaction. However, such traditional advertising links are limited in several ways.

For example, some users may follow the link associated with the advertisement despite already having the application installed on their mobile computing device. For such users, providing a link to the download location provides a poor experience, even though these users have indicated an interest in the application.

As another example, advertisements can be more effective when they are promoting a particular experience within an application. For example, an advertisement may promote a popular song that is exclusively available via a given streaming application. While it would be beneficial to be able to launch the application and go directly to a stream for the advertised song, technology that is currently available does not allow such an intent to be passed to the application in all cases if the application is not yet installed upon interacting with the advertisement.

What is desired is systems or methods that provide an improved experience for users interacting with an advertisement for an application, whether or not a mobile computing device associated with the user already has the application installed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method of opening an application referenced by an advertisement is provided. An end user computing device presents an advertisement for an application. The end user computing device determines whether the application is installed on the end user computing device in response to a user interaction with the advertisement. The end user computing device redirects to an application provider computing device for download and installation of the application in response to determining that the application is not installed, and executes the application.

In some embodiments, a system is provided that comprises a tracking data store and a tracking server. The tracking data store is configured to store a set of user click records. The tracking server is configured to receive a click notification from an end user computing device, the click notification including an intent; create a user click record in the tracking data store, the created user click record including the intent; and provide the intent in response to receiving a notification that an application associated with the click notification is executing on an end user computing device.

In some embodiments, a computer-readable medium having computer-executable instructions stored thereon is provided. The instructions, in response to execution by one or more processors of an end user computing device, cause the end user computing device to perform actions comprising retrieving, upon a first execution of an application by the end user computing device, an intent associated with an advertisement for the application that was presented and interacted with on the end user computing device; and performing at least one action indicated by the intent.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic diagram that illustrates an exemplary embodiment of a tracking ecosystem according to various aspects of the present disclosure;

FIGS. 2A and 2B are block diagrams that illustrate details of an exemplary embodiment of an end user computing device, an advertisement providing computing device, a customer computing device, an application provider computing device, and a tracking system according to various aspects of the present disclosure;

FIGS. 3A-3C are a flowchart that illustrates an exemplary embodiment of a method of opening an application referenced by an advertisement according to various aspects of the present disclosure;

FIGS. 4 and 5 illustrate two exemplary embodiments of splash pages according to various aspects of the present disclosure; and

FIG. 6 is a diagram of hardware and an operating environment in conjunction with which implementations of the one or more computing devices of the ecosystem may be practiced.

### DETAILED DESCRIPTION

### Tracking System Overview

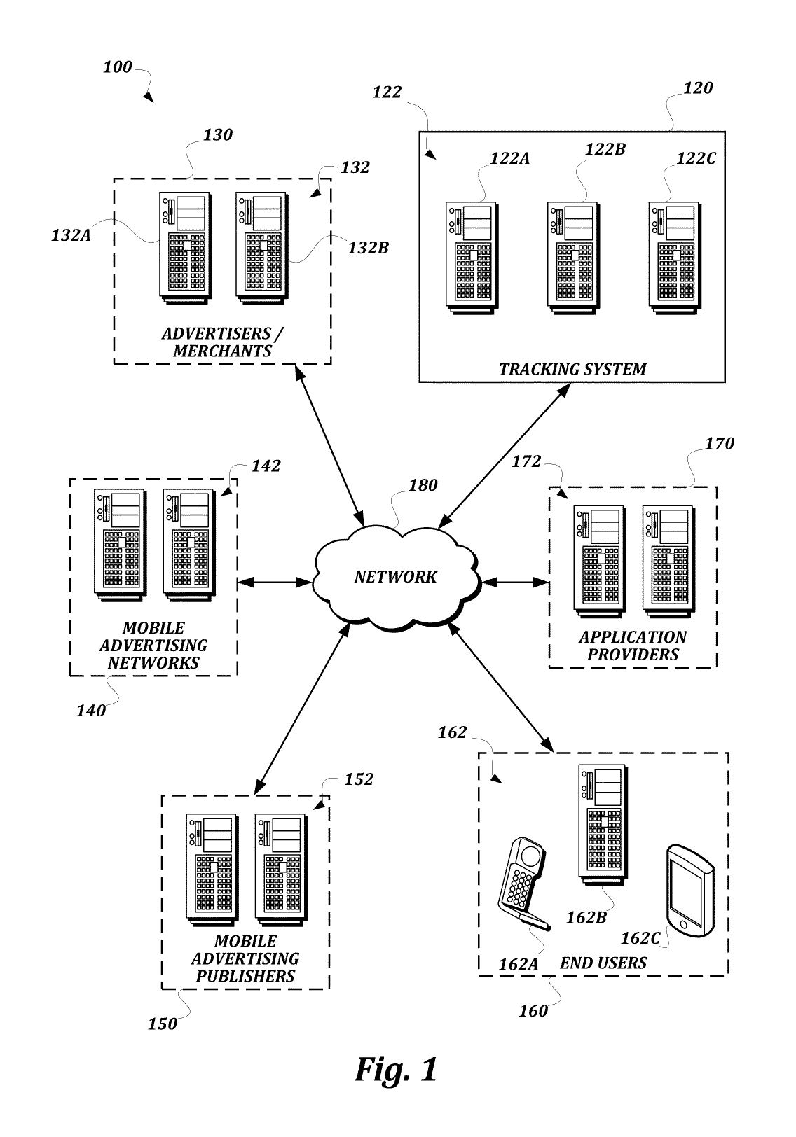

FIG. 1 is a schematic diagram that illustrates an exemplary embodiment of a tracking ecosystem 100 according to various aspects of the present disclosure. The tracking ecosystem 100 may be configured to provide advertisements to end users, wherein the advertisements include intents to be processed by an advertised application whether or not the application is yet installed on an end user computing device.

As illustrated, the system 100 includes a tracking system 120. The tracking system 120 includes one or more computing devices 122. In the embodiment illustrated, the computing devices 122 include a tracking server 122A, a storage service server 122B, and a management interface server 122C. In alternate embodiments, the computing devices 122 may include multiple tracking servers, multiple storage service servers, and/or multiple management interface servers. In some embodiments, the storage service server 122B is external to (and optionally remote from) the tracking system 120. In other embodiments, the functionality of the tracking server 122A and the storage service server 122B may be combined on a single computing device (not shown). In some embodiments, the functionality of the tracking server 122A and the management interface server 122C may be combined on a single computing device (not shown). The tracking system 120 is not limited to the use of a particular number of computing devices to implement the functionality of the tracking server 122A, the storage service server 122B, and the management interface server 122C.

The system 100 also includes one or more computing devices 132 operated by one or more Advertisers/Merchants 130, one or more computing devices 142 operated by one or more Mobile Advertising Networks 140, one or more computing devices 152 operated by one or more Mobile Advertising Publishers 150, a plurality of computing devices 162 operated by a plurality of End Users 160, and one or more computing devices 172 operated by one or more Application Providers 170.

As is apparent to those of ordinary skill in the art, in some embodiments, a single entity may function as one of the Advertisers/Merchants 130, one of the Mobile Advertising Networks 140, and one of the Mobile Advertising Publishers 150, even though they are illustrated in FIG. 1 as separate entities. Such an entity may operate one or more computing devices (not shown) that perform the functions of the computing devices 132, 142, and 152.

The Advertisers/Merchants 130 include companies that wish to advertise products and/or services. In some embodiments, the products are applications to be installed on end user computing devices 162.

The Mobile Advertising Networks 140 include companies that help distribute advertisements for the Advertisers/Merchants 130 for presentation to end users. The Mobile Advertising Networks 140 may provide services to Mobile Advertising Publishers 150 that allow Mobile Advertising Publishers 150 to present advertisements received from the Mobile Advertising Networks 140 to end users. Non-limiting examples of such companies include Google (the AdWords platform), Apple (the iAd platform), Millennial Media, Tapjoy, InMobi, Advertising.com, AdColony, Jumptap, Nexage, and the like.

The Mobile Advertising Publishers 150 include providers of web sites and mobile applications that display advertisements. Non-limiting examples of such companies include Pandora, Spotify, Facebook, Twitter, Bittorrent.com, The Weather Channel, and any other application or website provider that displays advertisements. In some embodiments, a company may act as both a Mobile Advertising Network 140 and a Mobile Advertising Publisher 150.

The End Users 160 include people who use the computing devices 162 and view advertisements, such as those created by the Advertisers/Merchants 130, distributed by the Mobile Advertising Networks 140, and/or displayed by the Mobile Advertising Publishers 150. The End Users 160 may also use the computing devices 162 to purchase, download, install, and/or interact with applications provided by the Application Providers 170.

The Application Providers 170 include companies that provide installable applications to the End Users 160. Non-limiting examples of such companies include “app stores,” such as iTunes App Store, Google Play, Amazon Appstore, and the like. The one or more computing devices 172 may be configured to provide a download location (not shown) from which an application may be purchased, downloaded, and/or installed. The download page may be implemented as a webpage, an application programming interface (API) accessible by a client application executing on the end user computing devices 162, or in any other suitable way. The installable applications may include advertising functionality configured to present advertisements to the end user and to report tracking information to be consumed by the tracking system 120.

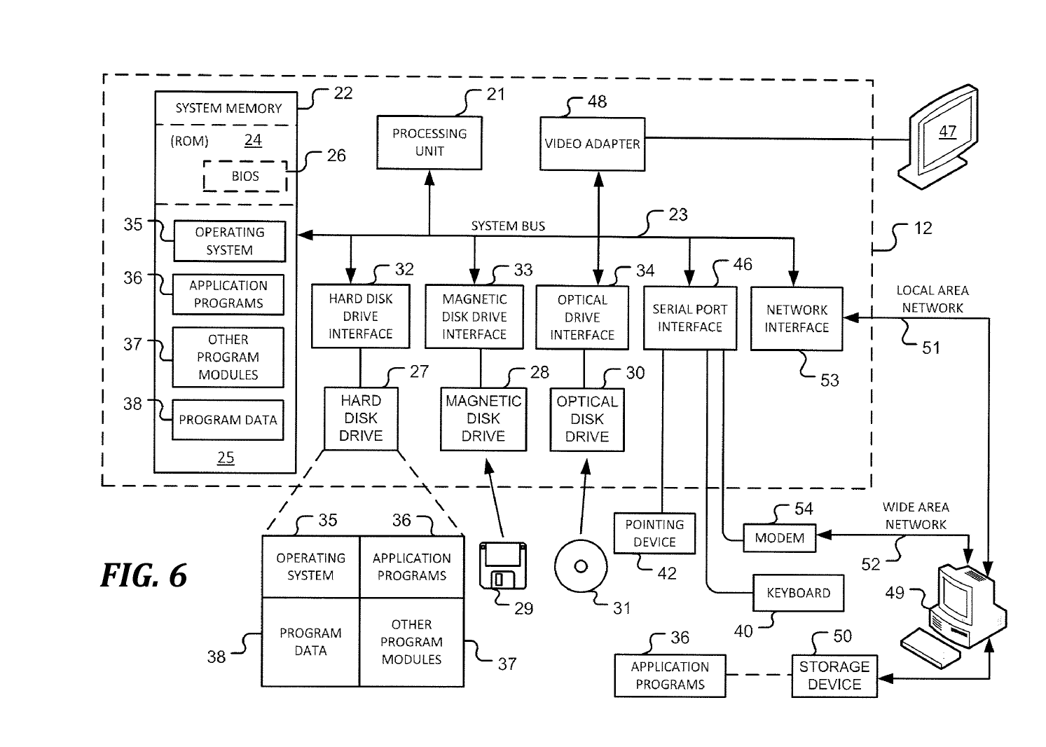

The computing devices 122, 132, 142, 152, 162, and 172 are connected to one another by a network 180 (e.g., the Internet). Each of the computing devices 122, 132, 142, 152, 162, and 172 may be implemented using a computing device similar to the computing device 12 illustrated in FIG. 6 and described below. By way of non-limiting examples, the computing devices 162 have been illustrated as including a smartphone 162A, a personal computer 162B (e.g., a desktop computer), and a tablet computer 162C. Each of the computing devices 162 may be configured to implement an advertisement displaying application.

### Opening an Application to Execute an Intent Provided in an Advertisement

In some embodiments of the present disclosure, functionality is provided that allows a similar targeted marketing experience to be presented to end users using mobile computing devices regardless of whether the mobile computing device initially has an advertised application installed before interacting with an advertisement that includes an intent.

While opening a newly installed application to a default start screen may be desired in some cases, in some embodiments it may be desired to direct a user to a specific screen or otherwise cause even a newly installed application to perform specific actions upon launch. The ability to defer the execution of an intent until after a previously missing application is installed on a mobile device can provide multiple benefits that are not currently available from existing technology.

As an example of a benefit provided by being able to provide an intent associated with an advertisement to a newly installed application, in some embodiments, such functionality can improve conversions by providing personalized content within the application. For example, consider a situation where a first user (User 1) challenges a second user (User 2) to play a game via a link transmitted by SMS. If user-specific data about User 1 can be included in the link transmitted by SMS and later be provided to the game application once it is installed, then a login screen can include information about User 1 instead of including a generic message. So, if the login screen is, for example, a Facebook Connect button, the personalized message could state, “Connect to Facebook to accept User 1's challenge” and show User 1's profile picture, as opposed to displaying a generic message such as “Connect to Facebook to challenge your friends.” This personalization can improve conversion rates of users and encourage them to use the advertised application after it is installed.

As another example of a benefit of being able to provide an intent associated with an advertisement to a newly installed application, in some embodiments, the application developer may choose to alter the user experience for new users compared to existing users. For example, in a casino application that has multiple game types, the application developer may choose to emphasize slots versus blackjack depending on information provided in the link from the advertisement, such as identification of an acquisition channel by which the advertisement was distributed, demographic data about the user that was used for targeting, details about the advertising content the user was exposed to, and/or the like.

As yet another example of a benefit, in some embodiments, the application developer can provide different incentives depending on an associated marketing promotion. For example, if the intent included with the advertisement indicates that the advertisement was delivered to a particular channel in which a special offer for $9.99 in free in-app purchases was promised (where this offer was not extended to other channels), such an incentive could be provided to only those users who obtained the advertisement and interacted with it via the channel. Without the use of the intent and other information included in the tracking link distributed with the advertisement, the application would have to honor the offer across all users because it wouldn't be able to differentiate how the users arrived at the application.

As yet another example of a benefit, some embodiments provide for seamless installation of content viewing applications based on advertisements for content viewable with those applications, even in situations where an install referrer is not passed to the application after installation. As a nonlimiting example, an advertisement for a streaming audio service (such as Spotify and/or the like) may advertise a particular song (e.g., the song “Diamonds” by the artist Rihanna). If a user taps on the advertisement on their mobile computing device, the tracking server may record device identifying information for the mobile computing device, along with an intent associated with the song before transmitting a splash page or redirect to the mobile computing device. Once the Spotify app is installed on the mobile computing device using logic in the splash page and/or the redirect and the Spotify app is executed, a tracking SDK in the Spotify app is used to contact the tracking server. The tracking server replies with the stored intent, and the Spotify app plays the song “Diamonds” without further interaction required by the user to select or play the song.

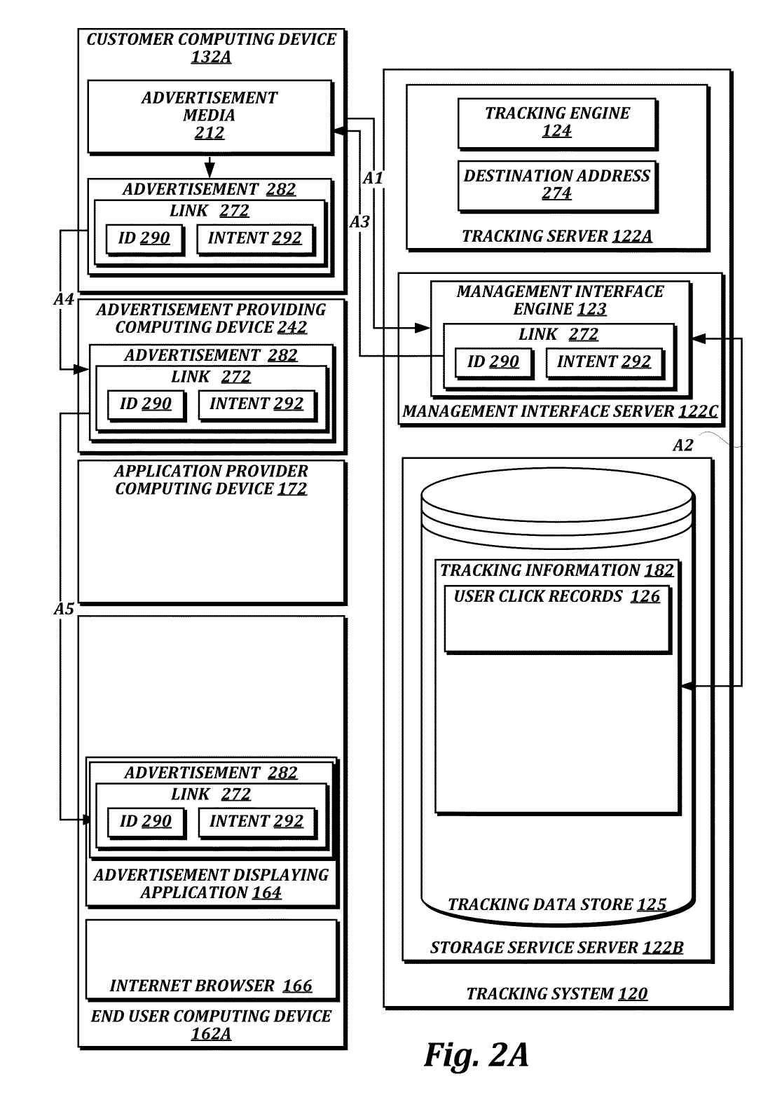

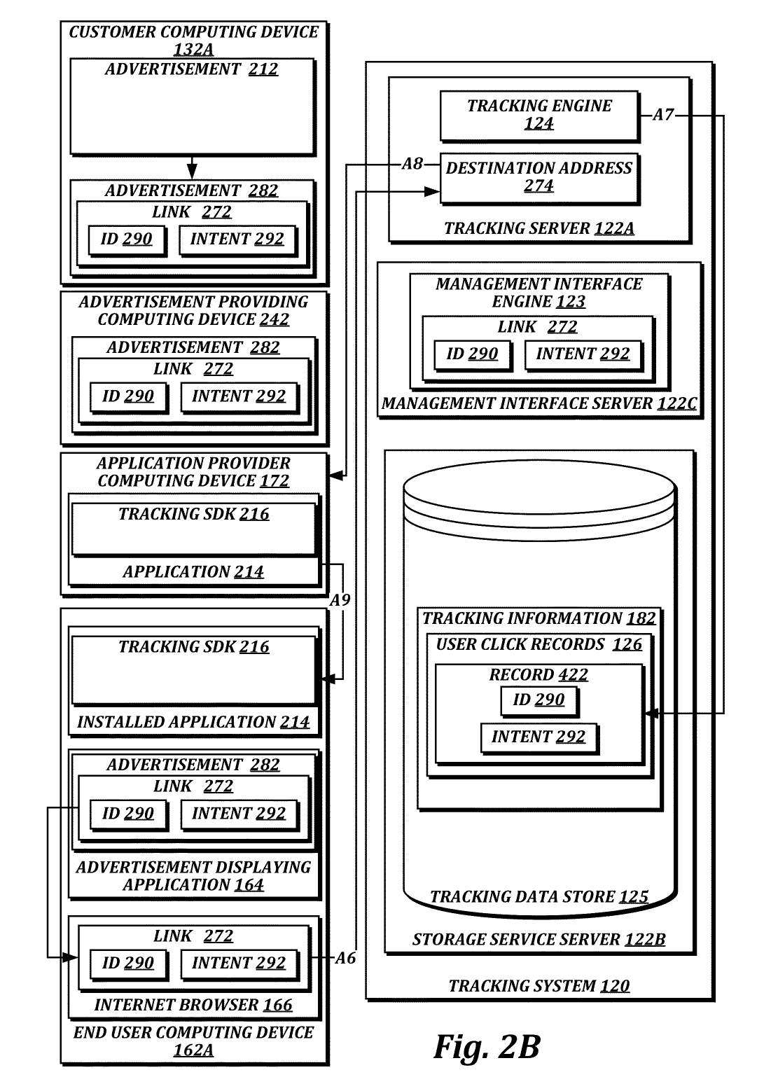

FIGS. 2A and 2B are block diagrams that illustrate details of an exemplary embodiment of an end user computing device 162A, an advertisement providing computing device 242, a customer computing device 132A, an application provider computing device 172, and a tracking system 120 according to various aspects of the present disclosure.

The tracking server 122A is configured to provide a tracking engine 124 that communicates with the storage service server 122B. In general, the term “engine” as used herein refers to logic embodied in hardware or software instructions, which can be written in a programming language, such as C, C++, Objective-C, COBOL, JAVA™, PHP, Perl, HTML, CSS, JavaScript, Ruby, VBScript, ASPX, Microsoft .NET™ languages such as C#, and/or the like. An engine may be compiled into executable programs or written in interpreted programming languages. Software engines may be callable from other engines or from themselves. Generally, the engines described herein refer to logical modules that can be merged with other engines or applications, or can be divided into sub-engines. The engines can be stored in any type of computer-readable medium or computer storage device and be stored on and executed by one or more general purpose computers, thus creating a special purpose computer configured to provide the engine.

The storage service server 122B is configured to provide a tracking data store 125 that stores user click tracking and/or other information received from the tracking server 122A and/or the management interface server 122C. As understood by one of ordinary skill in the art, a “data store” as described herein may be any suitable device configured to store data for access by a computing device. One example of a data store is a highly reliable, high-speed relational database management system (DBMS) executing on one or more computing devices and accessible over a high-speed network. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, as described further below. One of ordinary skill in the art will recognize that separate data stores described herein may be combined into a single data store, and/or a single data store described herein may be separated into multiple data stores, without departing from the scope of the present disclosure.

In some embodiments, the tracking data store 125 is configured to store tracking information 182 that includes a set of user click records 126. Each record of the set of user click records 126 represents an interaction (such as a click, a tap, a selection, and/or the like) with an advertisement 282 on an end user computing device 162. In some embodiments, the user click records 126 may be linked to a given end user computing device 162 by device identifying information. The device identifying information may include one or more device identifiers that may be assigned to the computing devices 162 to uniquely identify the computing devices 162, and may be used by the tracking system 122 to uniquely identify the end user computing device 162A or the user thereof.

Examples of device identifiers include, but are not limited to, a media access control (“MAC”) Address, an International Mobile Station Equipment Identity (“IMEI”), a Mobile Equipment Identifier (“MEID”), an Identifier for Advertising (“IFA”), an Identifier for Vendor (“IFV”), an Android ID, an Open Device Identification Number (“ODIN”), an Open Unique Device Identifier (“Open UDID”), a Google AdID, combinations thereof, and the like. By way of a non-limiting example, the IMEI may be an Android IMEI. By way of another non-limiting example, the MEID may be an Android MEID. Another example of a device identifier is a unique value assigned to the end user computing device 162 by the tracking system 120.

Other information associated with one of the computing devices 162 may also be used as device identifying information, and may include an Internet Protocol (“IP”) Address, browser information (e.g., browser type, browser version, a cookie, etc.), combinations thereof, and the like. This other information may be usable to identify a computing device 162, though the other information may be less reliable for uniquely identifying a computing device 162 than the device identifiers. Optionally, all or a portion of the device identifying information may be hashed before being used by the tracking system 120 as an identifier or to associate records in the tracking data store 125 with the end user computing device 162.

An example system wherein user click records stored in a tracking data store 125 may be used to attribute actions to one or more advertising publishers 150 and provide credit to the attributed publishers may be found in commonly owned, co-pending U.S. patent application Ser. No. 14/304,757, filed Jun. 13, 2014, the entire disclosure of which is hereby incorporated by reference for all purposes. One of ordinary skill in the art will recognize that similar techniques may be used by the ecosystem 100 described herein for attribution of actions to advertising publishers 150.

The management interface server 122C includes a management interface engine 123 configured to generate a management interface, described below. One aspect of the management interface engine 123 is configured to access (e.g., via an Application Programming Interface (“API”) or other suitable technique) the information stored in the tracking data store 125 and use the information to generate displays (e.g., graphs, charts, lists, reports, etc.) for the management interface. Another aspect of the management interface engine 123 is configured to generate a management interface that allows customers to create links that may be used to track advertisement performance and provide intents associated with advertisements, as illustrated and described further below.

The management interface engine 123 may include or communicate with web server components (not shown) configured to present conventional webpages displayable by conventional Internet browser applications executing on computing devices, such as a computing device 12 illustrated in FIG. 6 and described below. The management interface presented by the management interface engine 123 may include one or more web pages that may be transmitted by the web server components (not shown) to other computing devices in the ecosystem 100. Such web pages may be displayed by conventional Internet browser applications executing on the recipient computing devices.

As illustrated in FIG. 2A, the end user computing device 162A includes an advertisement displaying application 164 and an internet browser 166. The advertisement displaying application 164 may be any application configured to retrieve an advertisement from the advertisement providing computing device 242 and present it to an end user. In some embodiments, the advertising displaying application 164 may be the internet browser 166 itself, while in some embodiments, the advertising displaying application 164 may be some other type of application that includes functionality for retrieving and displaying advertisements. In some embodiments, the internet browser 166 is any type of application capable of retrieving and displaying content from the internet, such as a built-in web browser, a third party web browsing application, and/or the like.

In some embodiments, the customer computing device 132A and the advertisement providing computing device 242 create and distribute the advertisement. The customer computing device 132A is operated by a customer having an application or service to advertise, and for which the customer wishes to provide an intent along with the application. Accordingly, the customer uses the management interface to generate a tracking link 272. This action is represented by arrow A1 in FIG. 2A. The tracking link 272 includes the intent 292 and an advertisement identifier 290, and refers to the destination address 274 on the tracking server 122A. The management interface retrieves the unique advertisement identifier 290 from the tracking data store 125, which is represented by arrow A2. Once the link is generated by the management interface, it is provided to the customer computing device 132A, as indicated by arrow A3. The customer then combines the tracking link 272 with advertisement media 212, and provides the combination (as indicated by arrow A4) to the advertisement providing computing device 242 for distribution to end user computing devices 162 (as indicated by arrow A5). The advertisement providing computing device 242 could be an ad network computing device 142, an ad publisher computing device 152, or any other suitable computing device in the ecosystem 100 that distributes advertising to end users 160.

Turning to FIG. 2B, when the user interacts with the advertisement 282 on the end user computing device 162A, the tracking link 272 is loaded by the internet browser 166 and a click notification is transmitted to the destination address 274 (as indicated by arrow A6). The tracking engine 124 subsequently stores a user click record 422 in the tracking data store 125 that includes the advertisement identifier 290 and the intent 292 from the tracking link 272, as well as device identifying information (not pictured) that identifies the end user computing device 162A. The storage of the user click record 422 is indicated by arrow A7.

The tracking server 122A then redirects the end user computing device 162A to a splash screen for opening the application 214. In cases where the application 214 is not yet installed on the end user computing device 162A, the end user computing device 162A is redirected to the application provider computing device 172. This redirection is indicated by arrow A8. The end user computing device 162A then downloads and installs the application 214 from the application provider computing device 172, as indicated by arrow A9.

The application 214 includes a tracking Software Development Kit (SDK) 216. The tracking SDK 216 is provided to the developer of the application 214 by the tracking system 120 and includes functions and/or procedures that execute when called from within the application 214. The functions and/or procedures may be used to report tracked activity on the end user computing device 162A to the tracking system 120, and/or to retrieve information relevant to the end user computing device 162A from the tracking system 120.

By way of a non-limiting example, the tracking SDK 216 may be implemented as a library file that is included in an application project used to create the associated application. An application developer may use the tracking SDK 216 to report installation of the application to the tracking engine 124 upon first execution of the application, and may use the tracking SDK 216 to retrieve an intent 292 stored by the tracking system 120. As another non-limiting example, in some embodiments the functionality described herein as being provided by the tracking SDK 216 may not be included in a library file that is included in the application project used to create the associated application, but is instead accessed by virtue of the application performing remote function calls to an application programming interface (API) provided by the tracking system 120, the advertisement providing computing device 242, or some other element of the ecosystem 100.

Once the application 214 is executed, the intent 292 is provided to the application for execution. Further details of the process of creating advertisements and providing and executing intents for installed applications are provided below.

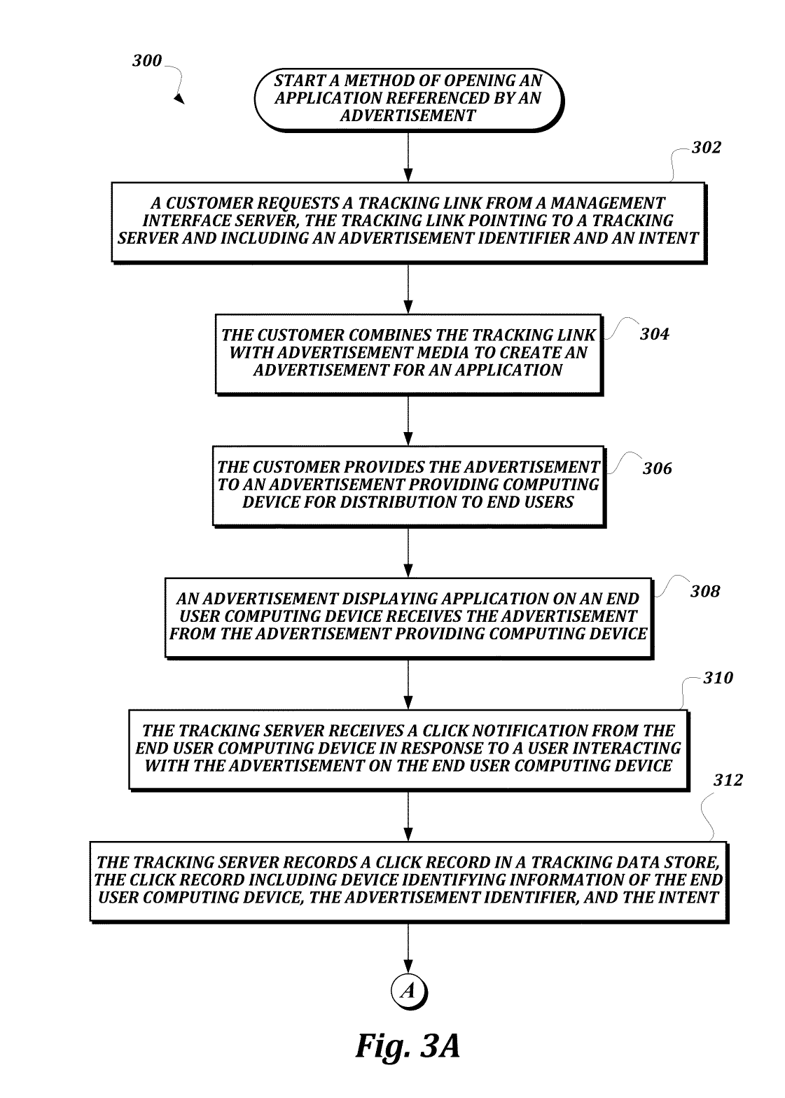

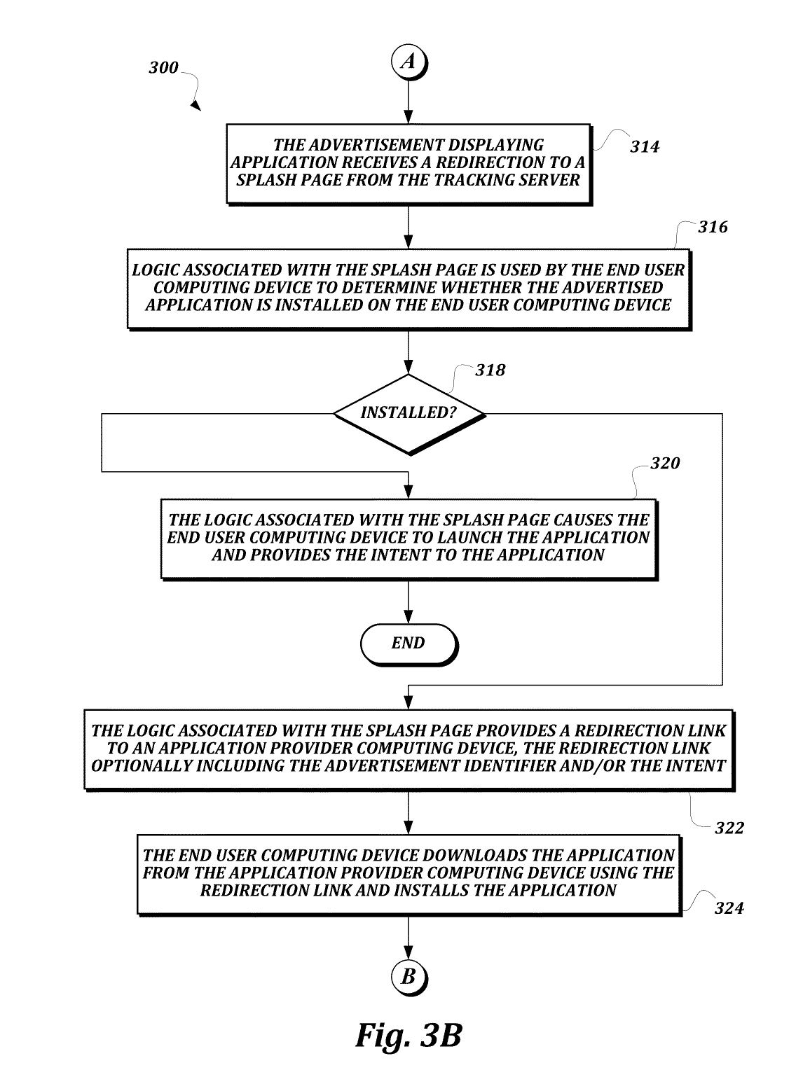

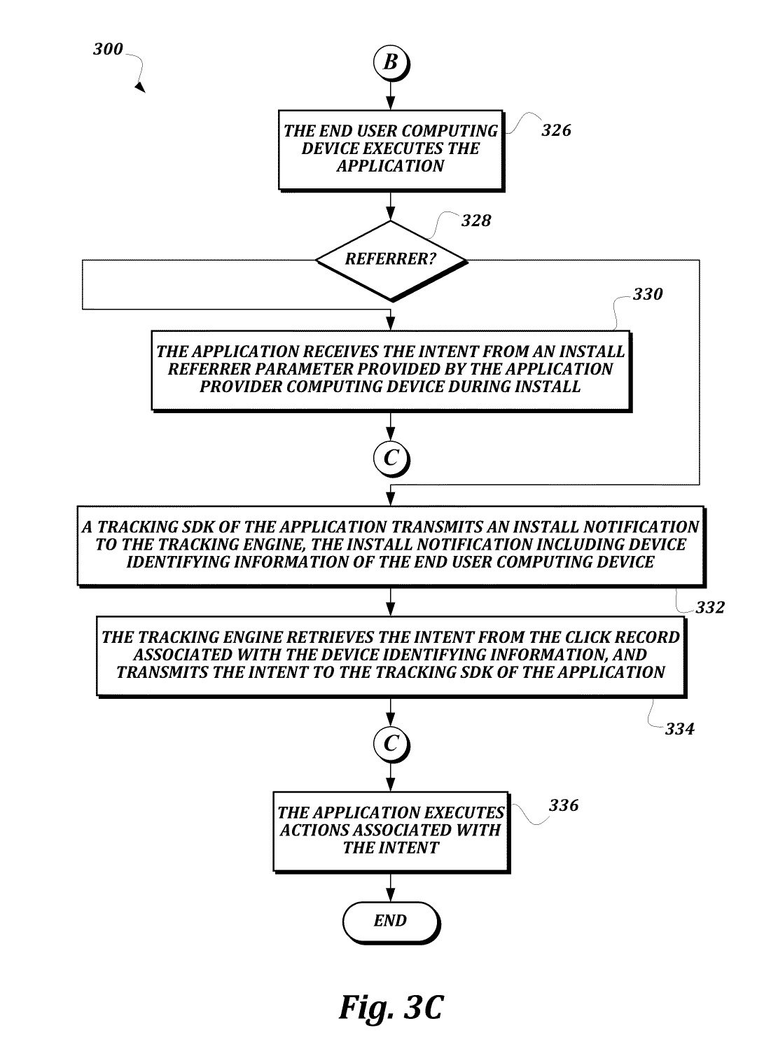

FIGS. 3A-3C are a flowchart that illustrates an exemplary embodiment of a method 300 of opening an application referenced by an advertisement according to various aspects of the present disclosure. One of ordinary skill in the art will note that though there are logical branches, every path through the method 300 results in the application 214 being opened and executing the same intent 292, regardless of whether or not the application was installed before the method 300 began executing, or how the intent 292 is provided to the application 214. This consistent marketing experience is an example of a benefit of the present disclosure.

From a start block, the method 300 proceeds to block 302, where a customer requests a tracking link 272 from a management interface server 122C, the tracking link 272 pointing to a tracking server 122A and including an advertisement identifier 290 and an intent 292. The advertisement identifier 290 is a unique value that the tracking system 120 may use to associate a given advertisement with a future action, such as a user click. In some embodiments, the advertisement identifier 290 may be used instead of device identifying information, when available, to link a click on an advertisement to an intent 292 stored by the tracking data store 125. This may be more reliable than the use of device identifying information, at least because the advertisement identifier 290 is explicitly associated with the advertisement and the stored intent 292. As discussed above, the intent 292 may include a link or other parameters that specify actions to be taken within the application 214. In some embodiments, the request for the tracking link 272 may be transmitted via a management interface provided by the management interface engine 123, and may specify other parameters to be included in the tracking link 272 including, but not limited to, a publisher identifier, a site identifier, an offer identifier, and/or the like. The customer may obtain the tracking link 272 by cutting and pasting the link text from the management interface provided by the management interface engine 123, programmatically within an application used for interacting with the tracking system 120, or by any other suitable technique.

Next, at block 304, the customer combines the tracking link 272 with advertisement media 212 to create an advertisement 282 for an application, and at block 306, the customer provides the advertisement 282 to an advertisement providing computing device 242 for distribution to end users. The advertisement media 212 may be any type of media suitable for presentation as an advertisement on an end user computing device 162A, including but not limited to text, still images, animations, audio, video, and/or combinations thereof. The combination of the advertisement media 212 with the tracking link could comprise including both in a data structure to be transmitted to the advertisement providing computing device 242, could comprise submitting both separately to an interface provided by the advertisement providing computing device 172 for the submission of advertisements, or could comprise any other suitable technique. In some embodiments, the submission of the advertisement 282 to the advertisement providing computing device 242 may also include a specification of targeting information (such as desired user demographics, desired user locations, desired user interests, desired user behaviors, desired user connections, and/or the like, so that users likely to be interested in the intent advertised in the advertisement would be more likely to receive the advertisement.

At block 308, an advertisement displaying application 164 on an end user computing device 162A receives the advertisement 282 from the advertisement providing computing device 242. Next, at block 310, the tracking server 122A receives a click notification from the end user computing device 162A in response to a user interacting with the advertisement 282 on the end user computing device 162A. The interaction may include any suitable interaction, such as a tap, a click, and/or the like. At block 312, the tracking server 122A records a click record 422 in a tracking data store 125, the click record including device identifying information of the end user computing device 162A, the advertisement identifier 290, and the intent 292. In some embodiments, the device identifying information may be inserted into the tracking link 272 by a script before it is followed by the internet browser 166. In some embodiments, the device identifying information may be derived by the tracking server 122A from information submitted along with the click notification, such as HTTP headers and/or the like. In some embodiments, the click record 422 may not include one of the device identifying information or the advertising identifier 290. The method 300 then proceeds to a continuation terminal (“terminal A”).

From terminal A (FIG. 3B), the method 300 proceeds to block 314, where the advertisement displaying application 164 receives a redirection to a splash page from the tracking server. The splash page is displayed by the internet browser 166 as part of receiving a redirect received from the tracking server 122A. Partially due to the fact that the redirect functionality in traditional systems was considered the only important part of the redirect provided by advertising links, no further functionality would traditionally be provided in the splash page. However, after being redirected to an app store, if a user switched back to the internet browser 166, a blank page would be presented with the tracking link 272 in the address bar. This blank page is traditionally confusing to the user.

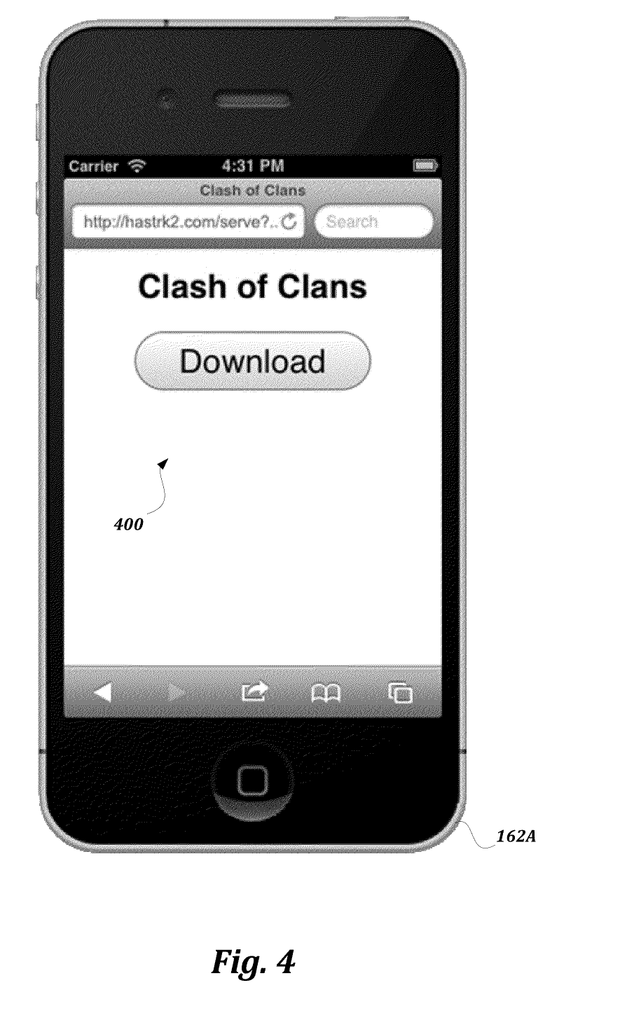

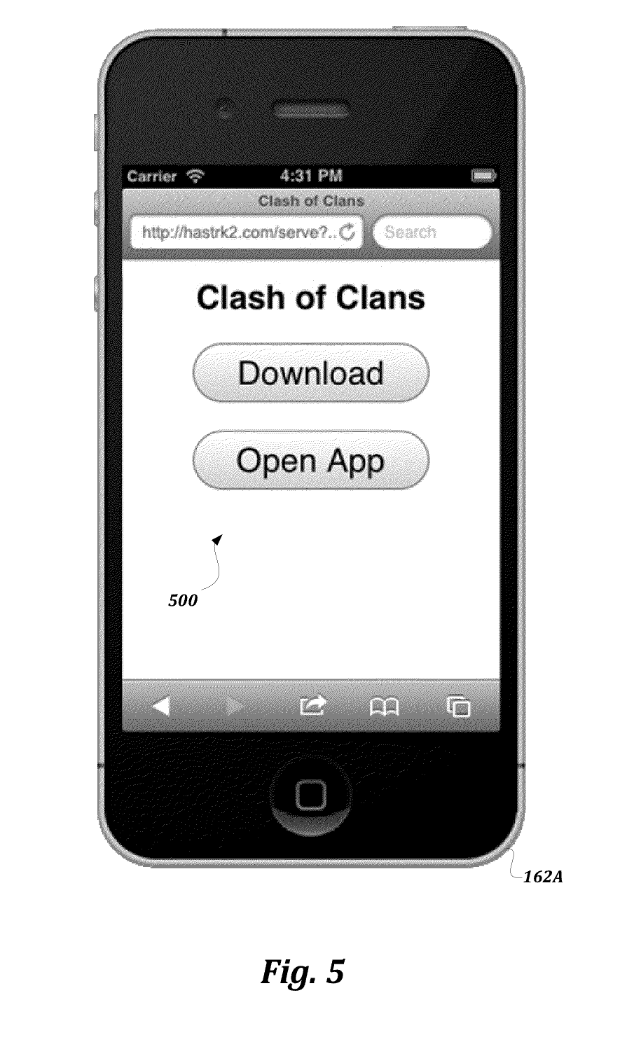

Accordingly, in some embodiments of the present disclosure, an improved splash page is provided as part of the redirection from the advertisement 282. FIGS. 4 and 5 illustrate two exemplary embodiments of splash pages according to various aspects of the present disclosure. These simple splash pages include buttons to invoke the associated links. As these splash pages may be loaded billions of times per month but only seen by a small percentage of users who switch back to the internet browser 166 after being redirected, the splash pages are designed to be extremely small in file size and to not include links to external images or other resources in order to ensure that the redirect is not unnecessarily delayed. In some embodiments, the splash pages are not branded and are kept generic in order to look user-friendly on any type of end user computing device 162A, whether it be an iPhone, an iPad, an Android device, a Kindle, a Windows Phone, or any other type of mobile computing device. In other embodiments, the splash pages may be branded by the tracking system 120 as requested by the customer to provide a better user experience. The splash page 400 illustrated in FIG. 4 includes an application download location link button, while the splash page 500 illustrated in FIG. 5 includes both an application download location link button and an invoke link button.

At block 316, logic associated with the splash page is used by the end user computing device 162A to determine whether the advertised application is installed on the end user computing device 162A. In some embodiments, the logic associated with the splash page may be in the form of JavaScript or other browser-executable code executed by the internet browser 166. In some embodiments, the logic may interface with an application on the end user computing device 162A other than the internet browser 166, such as an app store API or a directory of installed applications, in order to determine whether the advertised application is installed. In some embodiments, the logic may be simplified, and may simply attempt to launch the application 214 without first determining whether it is installed. In such an embodiment, the logic may monitor how long the splash page is displayed after attempting to launch the application. If the application is installed, then the end user computing device 162A will quickly launch the application, and the splash page will only be displayed for a short amount of time. However, if the application is not installed, the splash page will be displayed for a longer amount of time while the end user computing device 162A attempts to find the application. Accordingly, the logic may wait for a predetermined amount of time, such as one second, after which it will assume (if the splash page is still being displayed) that the application is not installed.

While the illustrated embodiment of the method 300 describes logic used by the end user computing device 162A to determine whether the advertised application is installed on the end user computing device 162A, in some embodiments, the tracking server 122A can determine whether the advertised application is likely to be installed on the end user computing device 162A, and may thereafter present a splash page that either redirects the end user computing device 162A to open the application or to access the application provider computing device 172 as appropriate. For example, the tracking server 122A may compare the device identifying information to records in the tracking data store 125 regarding computing devices which have previously installed the application 214, and may provide a splash page with a redirect to the application 214 if there is a record of the application 214 having previously been installed, and otherwise may provide a splash page with a redirect to the application provider computing device 172. As another example, the tracking server 122A may check the tracking data store 125 for records associated with the device identifying information that indicate that the application 214 has been launched on the device within a recent time period (e.g., within the last 7 days). If such records can be found, the tracking server 122A may present the splash page with the redirect to the application 214, and otherwise may present the splash page with the redirect to the application provider computing device 172.

The method 300 then proceeds to decision block 318, where a test is performed based on the determination of whether the advertised application is installed. If the advertised application was determined to be installed, then the result of the test at decision block 318 is YES, and the method 300 proceeds to block 320, where the logic associated with the splash page causes the end user computing device 162A to launch the application 214 and provides the intent 292 to the application 214. In some embodiments, the logic associated with the splash page uses application launching functionality provided by an operating system of the end user computing device 162A that allows for the passing of launch referrer information to the application 214. For example, the logic may invoke a custom URL handler as provided in iOS, and may pass portions of the link 272, including the intent 292 and/or the advertisement identifier 290, as one or more parameters to the custom URL. Once the application 214 has launched and received the intent 292 for execution, the method 300 then proceeds to an end block and terminates.

Otherwise, if the advertised application was determined to not be installed, then the result of the test at decision block 318 is NO, and the method 300 proceeds to block 322, where the logic associated with the splash page provides a redirection link to an application provider computing device 172, the redirection link optionally including the advertisement identifier 290 and/or the intent 292. In some embodiments, the redirection link may load in the internet browser 166. In some embodiments, the redirection link may cause a separate application, such as the iOS App Store, to be loaded in order to download the application 214. The advertisement identifier 290 and the intent 292 are described as optional for the redirection link because, as will be discussed further below, some technologies do not support the application provider computing device 172 providing install referrer information to the installed application, and so transmission of the advertisement identifier 290 and the intent 292 to the application provider computing device 172 would not serve its intended purpose.

The method 300 then proceeds to block 324, where the end user computing device 162A downloads the application 214 from the application provider computing device 172 using the redirection link and installs the application 214. One of ordinary skill in the art will recognize that there may be more than one level of redirection after visiting the initial redirection link, and that there may be more than one application provider computing device 172 provided by the application provider 170 from which the application may be downloaded and installed. The method 300 then proceeds to a continuation terminal (“terminal B”).

From terminal B (FIG. 3C), the method 300 proceeds to block 326, where the end user computing device 162A executes the application 214. Next, at decision block 328, the flow of the method 300 branches based on whether the install referrer is made available to the application 214. Some embodiments of end user computing devices 162A and application provider computing devices 172, such as Android devices and Google Play, respectively, support providing the install referrer to the application 214 after install, and some, such as iOS devices and the Apple App Store, do not. The branch chosen at decision block 328 will depend on what is supported by the end user computing device 162A and the application provider computing device 172. This behavior will usually be designed into the application 214 during development for the particular end user computing device 162A. In some embodiments, the type of computing device could be determined dynamically, but for ease of discussion, the description herein assumes that the developer knew the capabilities of the platform for which the application 214 was being developed.

If the end user computing device 162A does support providing an install referrer to a newly installed application as part of the native installation process, then the YES branch at decision block 328 is followed, and the method 300 proceeds to block 330, where the application 214 receives the intent 292 from an install referrer parameter provided by the application provider computing device 172 during installation. In such embodiments, the redirect link that sends the end user computing device 162A to the application provider computing device 172 may include at least some of the information from the tracking link 272, such as the intent 292, and intent 292 can therefore be provided as part or all of the install referrer string.

One example of such an embodiment exists when the Google Play store is used as the application provider 170 to install apps on an Android end user computing device 162. In such an embodiment, and assuming a hypothetical app called “HelloChatty,” a tracking link 272 such as the following may be provided to the end user computing device 162:

http://hastrk1.com/serve?action=click&publisher_id=1465&site_id=2385
&invoke_url=myapp%3A%2F%2Fviewproduct%3Fcategory%3Dshoes

In this tracking link 272, “hastrk1.com/serve” is the destination address 274, the “publisher_id” value of “1465” identifies the ad provider 242, the “site id” value of “2385” identifies the tracked application, and the “invoke_url” value includes the intent 292. The splash page will then provide a redirect to the user to an install location that includes the intent 292 and the advertisement identifier 290 in the referrer:

https://play.google.com/store/apps/details?id=com.hellochatty&
referrer=mat_click_id%3D3c1141949005aa9872-20140129-
877%26invoke_url%3Dmyapp%253A%252F%252Fviewproduct%253F
category%253Dshoes%0A

On the subsequent launch of the application 214, the tracking SDK 216 receives the install referrer value:

mat_click_id=3c1141949005aa9872-20140129-
877&invoke_url=myapp%3A%2F%2Fviewproduct%3Fcategory%3Dshoes

From this install referrer value, the tracking SDK 216 may extract and decode the advertisement identifier 290 of “3c1141949005aa9872-20140129-877” and the intent 292 of “myapp://viewproduct?category=shoes”.

The method 300 then proceeds to a continuation terminal (“terminal C”).

If the end user computing device 162A does not support providing an install referrer to a newly installed application as part of the native installation process, then the NO branch at decision block 328 is followed, and the method 300 proceeds to block 332, where a tracking SDK 216 of the application 214 transmits an install notification to the tracking engine 124, the install notification including device identifying information of the end user computing device 162A. At block 334, the tracking engine 124 retrieves the intent from the click record 422 associated with the device identifying information, and transmits the intent to the tracking SDK 216 of the application 214. One of ordinary skill in the art will recognize that this description assumes that the device identifying information uniquely identifies a click record 422. In some embodiments, the install notification may identify the application 214, as well, in order to disambiguate multiple click records 422 that match the device identifying information (such as, for example, embodiments wherein multiple different tracked applications 214 are installed on the end user computing device 162A).

The method 300 then proceeds from block 334 to terminal C, and from terminal C to block 336, where the application 214 executes actions associated with the intent 292. The method 300 then proceeds to an end block and terminates.

### Computing Device

FIG. 6 is a diagram of hardware and an operating environment in conjunction with which implementations of the one or more computing devices of the ecosystem 100 may be practiced. The description of FIG. 6 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, smartphones, network-connected tablet computers, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 6 includes a general-purpose computing device in the form of the computing device 12. Each of the computing devices of FIG. 1 (including the computing devices 122, 132, 142, 152, 162, and 172) may be substantially similar or identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feedback game controller).

The input devices described above are operable to receive user input and selections. Together the input and display devices may be described as providing a user interface. The user interface is configured to display portions of the management interface 123 to appropriate users.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 6 include a local-area network (LAN) 51 and a wide-area network (WAN) 52. Such networking environments are commonplace in offices, enterprise-wide computer networks, intranets and the Internet. The network 180 (see FIG. 1) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the method 300 illustrated in FIGS. 3A-3C) described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Accordingly, the invention is not limited except as by the appended claims.

1. A computer-implemented method of opening an application referenced by an advertisement, the method comprising:
presenting, by an end user computing device, an advertisement for an application;
determining, by the end user computing device, whether the application is installed on the end user computing device in response to a user interaction with the advertisement;
redirecting, by the end user computing device, to an application provider computing device for download and installation of the application in response to determining that the application is not installed; and
executing, by the end user computing device, the application.

2. The method of claim 1, wherein determining whether the application is installed includes:
presenting, by the end user computing device, a splash page;
submitting, by the end user computing device as instructed by logic included in the splash page, a command to an operating system of the end user computing device to launch the application; and
determining that the application is not installed upon detecting that the splash page is still being presented by the end user computing device after a predetermined amount of time has passed.

3. The method of claim 1, wherein executing the application includes providing an intent associated with the advertisement to the application for processing.

4. The method of claim 1, wherein redirecting to an application provider computing device for download and installation of the application includes:
visiting an install link to an application provider computing device, the install link including an intent; and
downloading and installing the application from the application provider computing device;
wherein executing the application includes providing the install link to the application via an install referrer parameter.

5. The method of claim 1, further comprising:
in response to the user interaction with the advertisement, transmitting a click notification to a tracking server, the click notification including device identifying information and an intent associated with the advertisement.

6. The method of claim 5, further comprising:
downloading and installing the application from an application provider computing device;
transmitting, by a tracking SDK within the application, an install notification to a tracking server in response to a first execution of the application, wherein the install notification includes the device identifying information; and
receiving, from the tracking server, the intent associated with the advertisement.

7. A system, comprising:
a tracking data store configured to store a set of user click records; and
a tracking server configured to:
receive a click notification from an end user computing device, the click notification including an intent;
create a user click record in the tracking data store, the created user click record including the intent; and
provide the intent in response to receiving a notification that an application associated with the click notification is executing on an end user computing device.

8. The system of claim 7, further comprising a management interface server configured to provide an interface for generating tracking links that include intents.

9. The system of claim 7, wherein providing the intent includes searching the set of user click records stored in the tracking data store for a matching user click record that matches device identifying information in the notification.

10. The system of claim 7, wherein providing the intent includes searching the set of user click records stored in the tracking data store for a matching user click record that matches an advertisement identifier in the notification.

11. The system of claim 7, wherein the tracking server is further configured to generate a splash page for presentation on the end user computing device.

12. The system of claim 11, wherein the splash page includes logic configured to determine whether the application is installed on the end user computing device.

13. The system of claim 11, wherein the splash page includes at least one of a link to open the application and a link to download the application.

14. A computer-readable medium having computer-executable instructions stored thereon that, in response to execution by one or more processors of an end user computing device, cause the end user computing device to perform actions comprising:
retrieving, upon a first execution of an application by the end user computing device, an intent associated with an advertisement for the application that was presented and interacted with on the end user computing device; and
performing at least one action indicated by the intent.

15. The computer-readable medium of claim 14, wherein retrieving the intent includes:
determining device identifying information of the end user computing device;
transmitting an installation notification to a tracking server; and
receiving the intent from the tracking server.

16. The computer-readable medium of claim 15, wherein the device identifying information includes at least one of a media access control (MAC) address, an International Mobile Station Equipment Identity (IMEI), a Mobile Equipment Identifier (MEID), an Identifier for Advertising (IFA), an Identifier for Vendor (IFV), an Android ID, an Open Device Identification Number (ODIN), a Google AdID, and an Open Unique Device Identifier (Open UDID).

17. The computer-readable medium of claim 14, wherein the at least one action indicated by the intent includes presenting indicated media content, providing an indicated discount, and presenting a personalized message.
